(19) United States
(12) Patent Application Publication
(10) Pub. No.: US 2018/0314378 A1
(43) Pub. Date: Nov. 1, 2018

(54) TOUCH CONTROL DEVICE CONFIGURED ON MIRROR

(71) Applicant: Dong Guan Song Wei Electric Technology Co., Ltd., Dongguan City (CN)

(72) Inventor: Weilin Lu, Dongguan City (CN)

(21) Appl. No.: 15/499,853

(22) Filed: Apr. 27, 2017

(51) Int. Cl. G06F 3/041; G06F 3/0354; A47G 1/00

(52) U.S. Cl. CPC G06F 3/0416; A47G 2200/08; A47G 1/00; G06F 3/03547

(57) ABSTRACT

A touch control device configured on a mirror includes a touch PCB (printed circuit board) board, touch panel and rear cover; a front face of the touch PCB board attached closely to a back face of the mirror, the front face of the touch PCB board configured with a plurality of touch pads each configured with an LED (light emitting diode) lamp; a silk screen layer adapted to display key information configured on the mirror, the LED lamps facing the silk screen layer, and the touch panel configured on a front face of the mirror and facing the silk screen layer; the rear cover configured on the back face of the mirror and adapted to cover the touch PCB board.

### TECHNICAL FIELD OF THE INVENTION

The present invention relates to a control device, and more particularly to a touch control device configured on a mirror.

### DESCRIPTION OF THE PRIOR ART

Control devices are used to control various equipment and systems, generally configured on equipment. Bathrooms also need control devices used to control illumination, warming systems and the like therein. The current mostly-used control devices are mechanical keys and touch screens. However, these current control devices are generally fixed on walls, making bathrooms not eye-appealing. In addition, the keys of these control devices cannot be hid, making the appearance thereof not pleasing to the eye and authenticity difficult to reflect.

### SUMMARY OF THE INVENTION

To overcome the defects mentioned above, the present invention is proposed.

The main object of the present invention is to provide a touch control device configured on a mirror, capable of solving the problems that current control devices in bathrooms can only be fixed on walls and keys thereof cannot be hidden, resulting in product appearances being not pleasing to the eye.

To achieve the object mentioned above, the present invention proposes a touch control device configured on a mirror, including a touch PCB (printed circuit board) board, touch panel and rear cover; a front face of the touch PCB board attached closely to a back face of the mirror, the front face of the touch PCB board configured with a plurality of touch pads each configured with an LED (light emitting diode) lamp; a silk screen layer adapted to display key information configured on the mirror, the LED lamps facing the silk screen layer, and the touch panel configured on a front face of the mirror and facing the silk screen layer; the rear cover configured on the back face of the mirror and adapted to cover the touch PCB board.

Preferably, the mirror is made of glass, coated plastics or acrylics.

Preferably, the front face of the touch PCB board is stuck to the back face of the mirror with super glue, and electronic elements are configured on a back face of the touch PCB board.

Preferably, a middle of said touch pad is configured a through hole allowing the LED lamp to be positioned therein, and the LED lamps are controlled by a MCU (micro control unit).

Preferably, an inductive conducting electrode is configured on the touch pad, the inductive conducting electrode being a spring or circuit board.

Preferably, the touch panel is printed directly on the front face of the mirror or stuck onto the mirror with a face sticker.

Preferably, the silk screen layer is positioned on the back face of the mirror.

Preferably, the rear cover is fixed on the back face of the mirror by the adsorption of two or more suckers.

Preferably, slide bars each adapted to adjust the adsorption force of the respective sucker are configured on the rear cover.

Preferably, the rear cover has a cavity, and the touch PCB board is positioned in the cavity.

The present invention has obvious advantages and beneficial effects compared to the prior art. Specifically, it can be seen from the above technical scheme that the device of the present invention is installed on a mirror instead of on a wall, making a bathroom pleasing to the eye; furthermore, in use, light emitted from the LED lamps irradiates the silk screen layer after turned on, and a very clear key pattern on the touch panel will be seen from the front face of the mirror; and the clear keys shown from the front face of the mirror will be disappeared when the LED lamps are turned off such that eyes cannot see the keys clearly, achieving the keys hiding object so that the appearance of the product is pleasing to the eye, the authenticity is reflected.

### BRIEF DESCRIPTION OF THE DRAWINGS

FIG. 1 is an exploded view of a preferred embodiment of the present invention.

### DETAILED DESCRIPTION OF THE PREFERRED EMBODIMENTS

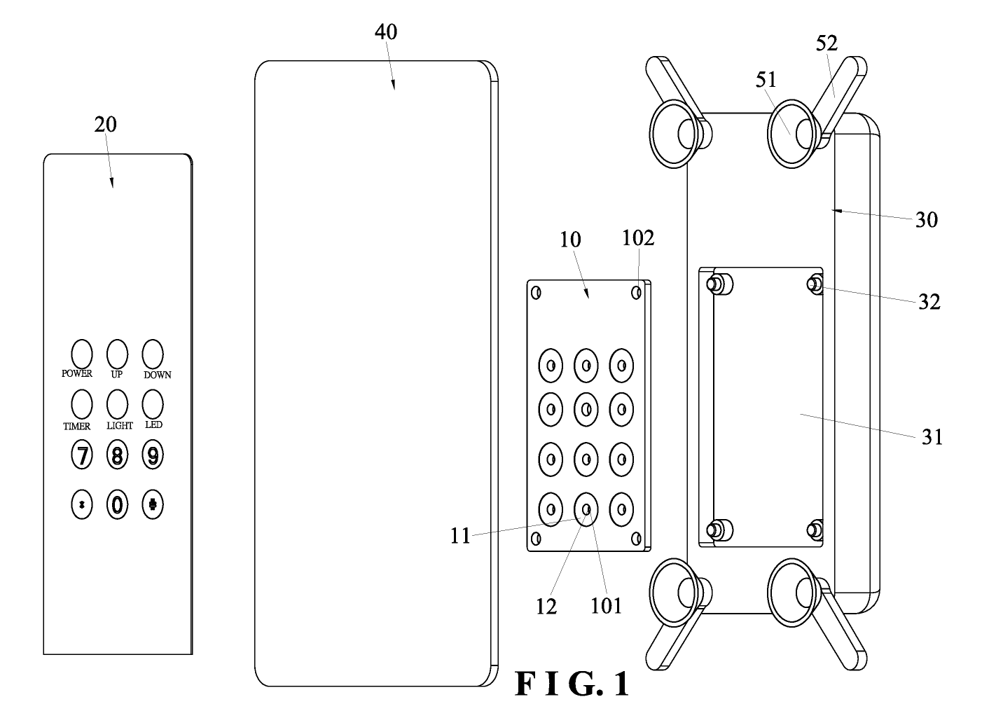

Referring to FIG. 1, a specific structure of a preferred embodiment of the present invention includes a touch PCB (printed circuit board) board 10, touch panel 20 and rear cover 30.

The front face of the touch PCB board 10 is attached closely to the back face of a mirror 40, and configured with a plurality of touch pads 11, on each of which an LED lamp 12 is configured. Furthermore, the mirror 40 is configured with a silk screen layer (not shown in the figure) adapted to shown keys' message, where the LED lamps are facing the silk screen layer. In the embodiment, the mirror 40 is made of glass, coated plastics or acrylics; the front face of the touch PCB board 10 is stuck to the back face of the mirror 40 with super glue; the back face of the touch PCB board 10 is configured with electronic elements (not shown in the figure); the middle of the touch pad 11 is configured with a through hole 101, in which the LED lamp 12 is positioned, where the LED lamp 12 is controlled by a MCU (micro control unit) of the touch PCB board 10, and has a luminous color such as red, yellow, green or blue. In addition, a manner for packing the LED lamp 12 may be a plug-in or patch package. Furthermore, the touch pad 11 is configured with an inductive conducting electrode (not shown in the figure) being a spring or circuit board. The silk screen layer is positioned on the back face of the mirror 40.

The touch panel 20 is configured on the front face of the mirror 40 and facing the silk screen layer. In the embodiment, the touch panel 20 is printed on the front face of the mirror 40 or stuck onto the mirror 40 with a face sticker, where the touch panel 20 is marked with printed character information or icon marks, and the keys and marks on the touch panel 20 are translucent windows without opening and not covered by a printed layer, the window being a light-emitting window for the LED lamp 12.

The rear cover 30 is configured on the back face of the mirror 40 and covers the touch PCB board 10. In the embodiment, the rear cover 30 is fixed to the back face of the mirror 40 by the adsorption of two or more suckers 51, where the rear cover 30 is configured with slide bars 52 adapted to adjust the adsorption force of the respective suckers 51. In addition, the rear cover 30 has a cavity 31, and the touch PCB board 10 is positioned in the cavity 31. Furthermore, the cavity 31 is projected with fixation rods 32, and the touch PCB board 10 is configured with fixation holes 102, the fixation rods 32 inserted in the respective fixation holes 102.

A use method of the embodiment is detailed as the following uniform scattering light will irradiate the silk screen layer on the back face of the mirror 40 when the LED lamps 12 of the touch PCB board 10, in use, is turned on such that the key images of the touch panel 20 can be clearly seem from the front face of the mirror 40, and the clear keys that appear from the front face of the mirror 40 will disappear or dim when the LED lamps 12 on the touch PCB board 10 is turned off, achieving a key hiding object.

I claim:

1. A touch control device configured on a mirror, comprising a touch PCB (printed circuit board) board, touch panel and rear cover; a front face of said touch PCB board attached closely to a back face of said mirror, said front face of said touch PCB board configured with a plurality of touch pads each configured with an LED (light emitting diode) lamp; a silk screen layer adapted to display key information configured on said mirror, said LED lamps facing said silk screen layer, and said touch panel configured on a front face of said mirror and facing said silk screen layer; said rear cover configured on said back face of said mirror and adapted to cover said touch PCB board.

2. The device according to claim 1, wherein said mirror is made of glass, coated plastics or acrylics.

3. The device according to claim 1, wherein said front face of said touch PCB board is stuck to said back face of said mirror with super glue, and electronic elements are configured on a back face of said touch PCB board.

4. The device according to claim 1, wherein a middle of said touch pad is configured a through hole allowing said LED lamp to be positioned therein, and said LED lamps are controlled by a MCU (micro control unit).

5. The device according to claim 1, wherein an inductive conducting electrode is configured on said touch pad, said inductive conducting electrode being a spring or circuit board.

6. The device according to claim 1, wherein said touch panel is printed directly on said front face of said mirror or stuck onto said mirror with a face sticker.

7. The device according to claim 1, wherein said silk screen layer is positioned on said back face of said mirror.

8. The device according to claim 1, wherein said rear cover is fixed on said back face of said mirror by the adsorption of two or more suckers.

9. The device according to claim 8, wherein slide bars each adapted to adjust the adsorption force of said respective sucker are configured on said rear cover.

10. The device according to claim 1, wherein said rear cover has a cavity, and said touch PCB board is positioned in said cavity.
